(19) United States
(12) Patent Application Publication
(10) Pub. No.: US 2022/0114670 A1
(43) Pub. Date: Apr. 14, 2022

(54) CROWDFUNDING 4.0: A NOVEL INFLUENCE-BASED GLOBAL FUNDRAISING PLATFORM AND SYSTEM

(71) Applicant: Fazal RAHEMAN, Nagpur (AE)

(72) Inventor: Fazal RAHEMAN, Nagpur (AE)

(21) Appl. No.: 17/417,593

(22) PCT Filed: Mar. 13, 2019
(86) PCT No.: PCT/IB2019/052047

§ 371 Date: Jun. 23, 2021

Related U.S. Application Data
(60) Provisional application No. 62/786,581, filed on Dec. 31, 2018.

(51) Int. Cl. G06Q 40/06

(52) U.S. Cl. CPC G06Q 40/06; G06Q 2220/12

(57) ABSTRACT

This invention relates to a novel decentralized computer-enabled platform and system for incentivized and equitable sharing and monetization of influence amongst peers for raising funds for novel projects without anyone actually having to pay for it in monetary terms. More specifically it discloses a new generation of crowdfunding 4.0 platforms that do not involve or risk cash investments in any form of fiat currency or cryptocurrency, but exclusively use influence of peers to fund projects. It essentially quantifies and tokenizes any tangible or intangible asset class known to prior art to create a new super asset class of influence capital. It is also a means of impact investing to plug the annual funding gap of trillions that's hampering United Nation's Agenda 2030 sustainable development goals (SDGs). Such impact investing exclusively uses the influence of SDG signatory countries, their nominees or sustainability stakeholders from private sector.

### TECHNICAL FIELD

This disclosure relates generally to the field of crowdfunding Specifically it relates to a decentralized computer-enabled system of crowdfunding of projects. More specifically it relates to a new generation of crowdfunding system that does not involve cash investments in any form of fiat currency or crytocurrency, but exclusively uses influence of peers to fund projects of all scales ranging from funding small scale enterprises to mobilizing Trillions of unutilized impact investing opportunities in UN's Sustainable Development Goals (SDGs) and other sustainable infrastructure projects such as China's multi-Trillion Belt & Road Initiative.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever. Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Oxford dictionary defines crowdfunding as “the practice of funding a project or venture by raising money from a large number of people who each contribute a relatively small amount, typically via the Internet.”

Since the birth of modern crowdfunding platforms in 2008-2009, technology has rapidly evolved from the first generation rewards, donations, debt based crowdfunding to equity and token-based ICOs:

1. Crowdfunding 1.0: Rewards, donation, debt based crowdfunding

2. Crowdfunding 2.0: Equity based crowdfunding

3. Crowdfunding 3.0: Token-based Initial Coin Offerings (ICO)

In rewards-based crowdfunding, backers contribute small amounts of money ranging between $1 and $1,000 or sometimes more in exchange for a reward. This reward is often, but not always, the item being produced, such as a gadget, an album or a film.

In donation-based crowdfunding, donors generally donate small amounts ranging between $1 and $1,000 or sometimes more. In most donation-based crowdfunding, the reward is usually the gratitude of the project creator or beneficiary. The money is raised for a charity or a cause by a non-profit initiative.

In debt-crowdfunding, it's not “backers” or “donors” who give money, but lenders who may also be called as investors. It's not an exchange for a reward, but instead investors make a loan with the expectation to get paid back the principal plus interest.

Crowdfunding 2.0: In equity-crowdfunding, investors give larger amounts of money in exchange for a small piece of equity in the company itself to fund or the launch or growth of a company.

Crowdfunding 3.0: An initial coin offering (ICO) or an initial token offering is a brand new type of crowd funding that became a craze amongst blockchain/cryptocurrency startups in 2017 raising over $6 billion, although half of them eventually finally failed. In an ICO, a quantity of the crowdfunded cryptocurrency is sold to investors in the form of “tokens”, in exchange for legal tender or other cryptocurrencies such as bitcoin or ethereum. These tokens are promoted as future functional units of currency if the ICO's funding goal is met and the project launches. ICOs provide a means by which startups avoid costs of regulatory compliance and intermediaries, such as venture capitalists, bank and stock exchanges, while increasing risk for investors. It is a means of raising capital that has been prone to scams and securities law violations. ICOs may fall outside existing regulations depending on the nature of the project, or are banned altogether in some jurisdictions, such as China and South Korea. In United States ICO may not be yet legally banned or legislated, but mandated to follow the four-step ‘Howey Test’ which was framed in the famous case—SEC v. Howey Co., 328 U.S. 293 (1946), which essentially asks four questions:

1. Are you investing money or assets?

2. Do you expect to make a profit from your investment?

3. Are you investing in a common enterprise? And,

4. Is the profit the result of a third party's actions, rather than your own?

If the answer is yes to all four questions, then the transaction is typically labeled a security.

All the evolved forms of crowdfunding known to prior art involve fair level of risk because investor funds are actually transferred to fundees account, and hence need to be regulated to protect investor interest. In Marine Bank v. Weaver, 455 U.S. 551, 102 S.Ct. 1220, 1221, 71 L.Ed.2d 409 (1982), the Supreme Court added a further limiting requirement to the Howey test: “for an instrument to be a security the investor must risk loss.”

Accordingly, there is a need for methods and systems that eliminate the investor risk altogether by not soliciting any transfer of money or asset, and making crowdfunding more seamless, transparent, less regulated, more accessible and scalable.

Moreover, the world is currently working towards a set of ambitious targets for addressing global challenges—Sustainable Development Goals (SDGs) and the Paris Climate Agreement. The costs of implementing these agreements, however, are astronomical. The UN estimates that of the $5 trillion to $7 trillion that costs annually for implementing the SDGs, there's $2.5 trillion annual funding gap. Global philanthropic funds, even when combined with the development or aid budgets of governments, add up to only billions of dollars. Conversely, an estimated $210 trillion is available in private capital for investment in global financial markets, but much of it is just sitting on the sideline. Private capital is urgently needed in order to fill the gap and address the pressing global challenges.

As reasons therefore this invention introduces the next generation of crowdfunding 4.0 that does not involve any fund transfer from the funder to the fundee directly or indirectly, but exclusively uses funders' tokenized influence using distributed ledger technology (DLT) such as blockchain to create, execute and store crowdfunding smart contracts, and generate or mine cryptocurrency tokens as rewards to be shared amongst the participating peers. The influence generating funds whether fiat or cryptocurrancy or anything tangible, remain under funders' control and disposal at all times subject to certain terms and conditions. It is to these ends that the present invention has been developed.

### BRIEF SUMMARY OF THE INVENTION

In technical terms the present invention discloses a decentralized computer-implemented crowdfunding platform that deploys DLT for incentivized and equitable sharing and monetization of influence of the peers, by the peers, for the peers, for the purpose of raising funds or kick starting projects. Such decentralized crowdfunding is pledged via a self-executing smart contract that does not require any of the funders to contribute any cash in monetary terms.

To fund and acquire a stake in a fundee project, it essentially requires no currency contribution in any form of fiat or cryptocurrency from a funder. The projects are funded exclusively by sharing influence of participating peers in the form of votes that support funding pledges, which are smart funding contracts, events or transactions that are verified and validated by the DLT/blockchain consensus engine comprising of validator peer nodes. As a new block/transaction/event is recorded and added to the permanent ledger, new tokens are generated to reward the peers who either staked their tokens (influence) or validated (mined) the blocks/transactions/events. After allotting the reward tokens to the influencers, block/transaction/event validators, a significant proportion of the new tokens are assigned to the funding pool, which the funders or their nominees use to vote or pledge to support the fundee projects.

Accordingly, it would be an improvement to provide a novel decentralized crowdfunding platform for incentivized and equitable sharing and monetizing influence of the peers, by the peers, for the peers for generating funds. It would also be an improvement to make such sharing and monetizing of influence safe, secure, seamless and risk-free. It would therefore be an improvement that such crowdfunding system is administered by means of an autonomous, peer-to-peer, decentralized, permissionless, trustless, network such as DLT or blockchain that maintains immutable cryptographically verifiable transaction records of all peer activities performed on the platform and generates or mines cryptocurrency tokens in the process. It would therefore be an improvement that such token or cryptocurrency denominations generated in proportion to the influence of funder peers are used to fund projects posted by participating fundees. Consequently it will also be an unprecedented improvement that the funders actually don't have to contribute anything in cash, essentially requiring no currency contribution in any form of fiat or cryptocurrency for acquiring a stake in the fundee project in the form of rewards, perks, gratuities, equities or tokens.

As reasons therefore it is an object of this invention to enable project creators or fundees to pitch their projects to the investors/influencers for supporting and funding the projects with their influence, in exchange for a stake in the projects. It is also further object of the invention to tokenize the influence based on the quantum of stake participating peers posses in their accounts on the platform as project creators, project curators, or project investors, measured in terms of cryptocurrency tokens they stake, or hashing power of block/transaction/event producing peers have, or their reputation scores, or intellectual property they own, or activities they conduct on the platform. It is yet another object of the invention to allow investors/influencers to delegate their influence to project curators, who curate the most fundable projects for a commission, if the influencers chose not to do their own research and due diligence to fund the projects. Hence, it is an object of the invention to recognize everyone's meaningful contribution to the community for the value it adds.

It is also another object of the invention to deploy low-latency DLT or blockchain which uses a transaction validation consensus protocol that includes but not limited to proof-of-work, proof-of-stake, delegated proof-of-stake or the variants thereof, for executing project-funding smart contracts and storing them as distributed ledger across all validation nodes.

It is also further object of the present invention to exploit the influence of all member nations of the United Nations in addressing some of the gravest threats to the sustainability of our planet earth. As reasons therefore it is also an object of this invention to provide an influence-based crowdfunding platform of the present invention for impact investment in funding global sustainability projects that implement one or more of the 17 sustainable development goals (SDGs) of the United Nations' Agenda 2030. It is further object of this invention to monetize the influence of SDG signatory countries or their nominees or SDG skateholders from private sector for enabling influence based impact investments in projects supporting SDGs. It is also further object of this invention to provide influence-based crowdfunding platform for mobilizing private investments for global infrastructure projects that complement UN's Agenda 2030 goals, such as China's Belt and Road Initiative (BRI).

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results as will be described in detail herein. Accordingly, referring to the following drawings may have a complete understanding of the invention and its preferred embodiments.

### BRIEF DESCRIPTION OF DRAWINGS

FIG. 1 is a block diagram illustrating the network architecture of a novel embodiment of the next generation influence-based crowdfunding infrastructure.

FIG. 2 is a block diagram illustrating the steps involved in implementing the novel method of influence-based crowdfunding.

FIG. 3 is a block diagram illustrating the global landscape of all types of tangible and intangible asset.

### DETAILED DESCRIPTION

The core feature of the instant invention is decentralized, seamless, autonomous, safe, secure and equitable sharing and monetization of influence of the peers, by the peers for the peers, for the purpose of raising funds for novel projects without anyone actually having to pay for it in monetary terms. Such novel next generation approach to crowdfund projects can be deployed in many different ways, and accordingly several embodiments of the invention are possible. Before a few preferred embodiments of the invention are described in detail, following technical terms used in describing the invention need to be clearly defined:

Influence/Tokenized Influence within the meaning of this disclosure implies the authority of a participating peer quantified and tokenized by means of the quantum of stake the peer posses in their accounts on the platform as project creators, project curators, or project funders, measured in terms of one or more of the following assets: i) cryptocurrency tokens they stake, ii) hashing power of the block producing, transaction/event validating peers, iii) their reputation scores, iv) intellectual property they own, and iv) activities they conduct on the platform. Alternatively, on a large scale almost anything one owns and uses for personal or investment purposes is a capital asset that can be quantified and tokenized into influence capital for the purpose of acquiring or making new asset investments. Hence any tangible and intangible asset class can be tokenized to create a Super Asset Class of Influence Capital.

Investment Tokens 152 are the new tokens 146 that are generated as mining rewards 148 and assigned to the funding pool 150 to fund projects submitted by project creators.

Funder/Investor/Influencer: These terms may be used interchangeably in illustrating various features and embodiments of the present invention. While usage of the term funder can be construed as used in common parlance, the terms investor and influencer explicitly imply a participating peer whose impact on the crowdfunding platform is tokenized based on the quantum of influence tokens staked on the platform. A curator may also be an influencer.

Project Creator/Fundee is a peer who pitches a project and receives funding from influencers who are also referred as funders or investors.

Project Curator is a peer who curates the best pitches by upvoting them with influence that may be delegated by the funder investor/influencer. The curator may be an expert in the field related to the fundee's project.

Impact investing refers to investments made into projects with the intention to generate a measurable, beneficial social or environmental impact alongside a financial return. With the exception of charity, crowdfunding is more or less impact investing.

Influenstor: Since English vocabulary carries no term that can appropriately describe a unique category of investors who engage in impact investing and actually do it without investing or putting at risk actual cash but uses influence, this disclosure coins a portmanteau term that combines terms: “influencer” and “investor” to create a new term Influenstor. The terms influencer, investor, funder, influenstor may be used interchangeably to imply a similar meaning throughout this disclosure. Although curators may also be influencers, they cannot be termed as influenstors.

Project Stake within the meaning of this invention refers to anything received by the funder from the fundee in exchange for the funds made available to the fundee. In reference to non-charity crowdfunding it could be one or more rewards such as a product or service funded, equity in the form of shares in the funded venture, or tokens that are redeemable or tradable against products, services, fiat currency or other cryptocurrency tokens of value. In reference to charity projects, it is gratuities in one or more forms of gratitude, such as appreciation, gratefulness or thankfulness.

Distributed Ledger Technology (DLT) or blockchain 138 is a decentralized distributed database that maintains a continuously growing list of data records hardened against tampering and revision. It consists of records of transactions/events or data structure blocks, wherein each block securely holds batches of individual transactions/events whether as cryptocurrency transactions, or events, or self-executing smart contracts.

Block Validators/Producers are peer nodes that run the consensus engine for recording all transactions/events in the permanent ledger. The term block validator/producer is interchangeably used to imply transaction/event validators where the DLT is not a blockchain.

Smart Funding Contract 136 is a self-executing smart contract between fundee, funder and curator, which defines the terms for funding projects via votes in support of fundee's project posts and comments therein. It also defines the terms of delegation of influence between funder and curator for delegating influence. Self-executing smart contracts of a preferred embodiment can also be implemented by deploying DAG's decentralized architecture.

Consensus Engine 140 is another key component of the DLT/blockchain infrastructure wherein each smart contract, transaction or event is verified by peer nodes 142 for adding it to the DLT/blockchain's permanent ledger 144 as a new block/transaction/event. For reaching the consensus the protocols deployed include but not limited to proof-of-work, proof-of-stake, delegated proof-of-stake or the variants thereof.

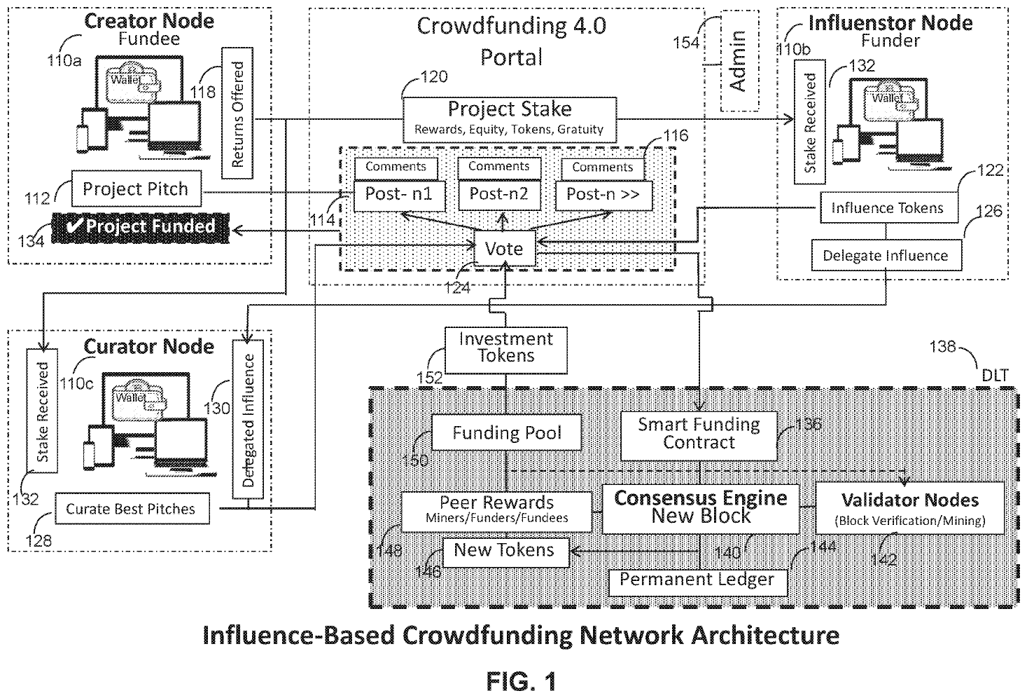

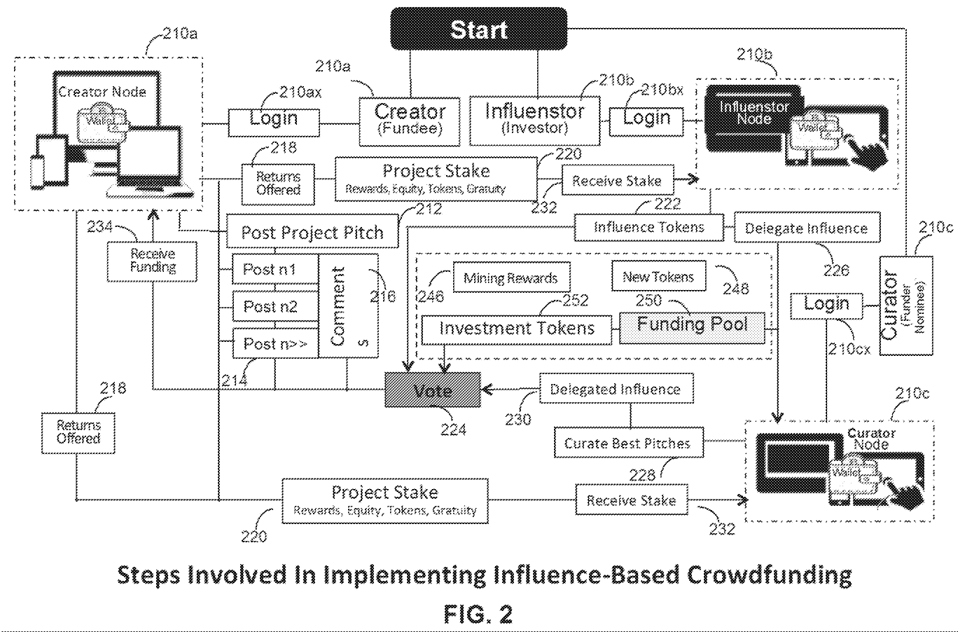

Embodiments of the present invention will now be described with reference to FIGS. 1-2, which in general relate to a new generation of decentralized computer-implemented system for crowdfunding projects exclusively by sharing the influence of project backers for generating or mining funds in one or more cryptocurrency denominations without any of the funders actually having to contribute any cash in monetary terms, essentially requiring no direct currency contribution in any form of fiat or cryptocurrency from a funder to a fundee for acquiring a stake in the fundee project pursuant to a self-executing smart contract.

As illustrated in FIG. 1, the infrastructure for implementing the novel influence-based crowdfunding platform, system and method of the present invention includes a network architecture and apparatus comprising of the following components or modules distributed and installed on the participating devices or remote servers comprising of the nodes that communicate with each other in a decentralized network:

Computer Nodes: The novel crowdfunding platform of the present invention comprise of at least 3 categories of computer nodes (user nodes 110, admin node 154 and block/transaction/event validator/miner nodes 142). The first category of user nodes 110 include, a computing device at the project creator/fundee node 110a, or at the investor/funder/influenstor node 110b, or at the project curator node 110c.

The project creator 110a posts his or her project pitch first as an introductory post 112, and subsequently a series of posts 114 over a period during which the crowdfunding remains active. Peers post comments, queries 116 that fundees respond to. Each project pitching post describes in sufficient details the project plan, financials, milestones, etc., along with the targeted funding goal, and returns offered 118 to the investors. The returns to the funder/influenstor/influencer is in the form of a stake in the project 120 depending on the type of project and, type of crowdfunding, offering rewards, equity, token or gratuity, for reward-based, equity-based, coin offering, or charity-based projects respectively. Each one of the funding posts and corresponding comments on the posts engage the influencers who are either investors/influenstors 110b or curators 110c.

The influence of participating peers is tokenized 122 based on the quantum of stake peers possess in their accounts on the platform as project creators, project curators, or project investors, measured in terms of one or more of the following assets: i) cryptocurrency tokens they stake, ii) hashing power of the block/transaction/event producing peers, iii) their reputation scores, iv) intellectual property they own, and iv) activities they conduct on the platform.

If the influenstors decide to fund the project with their tokenized influence 122, they either directly back the fundee project pitch or series of pitches using their influence 122 to upvote the fundee posts or comments thereof 124, or delegate their influence 126 to project curators, who curate the best project pitches 128 and use the delegated influence 130 to upvote them 124 on behalf of the investors/influenstors for a share in the rewards, gratuities, equities, tokens or coins to be received 132 from the project creators as a consideration for the project funding 134. The influencer/influenstor vote value is quantifiable to the quantum of stake they have on the crowdfunding platform in terms of the crowdfunding platform's cryptocurrency or tokens, and such value is transferred to the fundee with each upvote. The project creator/fundee thus receives funds equivalent to the influencers' vote value in platform's cryptocurrency or tokens, as per the terms and conditions of the self-executing funding smart contract. The project creator can convert the platform cryptocurrency or tokens into one or more appropriate spendable currencies in a cryptocurrency exchange and use it to achieve the specified goals of the project pitch. The project creator or fundee then delivers to the project backers or funders 132 such rewards, gratuities, equities, tokens or coins as pledged in the project pitch 112 and the self-executing smart contract 136. The platform uses a low or ultra-low latency DLT or blockchain network 138 not only to decentralize the network of peers, but to maintain the immutable records of all transactions, events or smart contracts with highest possible security, privacy, anonymity, and in the process generating or mining new tokens (funds) using a transaction validation consensus protocol that includes but not limited to proof-of-work, proof-of-stake, delegated proof-of-stake or the variants thereof. Each event on the platform is a transaction that is recorded on the platform by the consensus engine as a new block/transaction/event 140 validated by block validator or miner nodes 142 and stored in DLT/blockchain's database of distributed ledger 144. As an incentive to the block/transaction/event validators or miners, the consensus engine produces new tokens 146 as peer rewards 148, which are distributed amongst the peer nodes as rewards either to the block/transaction/event validators 142 or pooled in as funding pool 150 to be allocated to the participating peers according to their tokenized influence on the platform. The tokens from the funding pool can be used as investment tokens 152 to power up the funding votes 124 that support and fund the project pitches.

FIG. 2 is a block diagram illustrating the steps involved in implementation of a novel decentralized influence-based crowdfunding platform and system of the present invention. It begins with the peers 210a, 210b and 210c signing in to login to their respective computer terminals or nodes, either as project creators or fundees 210ax, as project investors, funders, influencers/influenstors 210bx, or as project curators 210cx. A project creator or fundee seeks funding by posting a project pitch 212 that spreads over a series of posts 214 that discuss the project's business plan in great detail responding to comments 216 and queries of the funders/influenstors 210b and curators 210c regarding financials, milestones, funding goals and returns offered 218 to the influenstors and also curators if explicitly provided in funding smart contract. The returns to the investor/funder/influenstor or curator is in the form of a stake 220 in the project depending on the type of project and type of crowdfunding, offering rewards, equity, token or gratuity, for reward-based, equity-based, coin offering, or charity-based projects respectively. Such terms and conditions are pre-defined in self-executing smart contracts auto-executed at each interaction between the peers on the platform.

In the next steps the investors/influenstors use their tokenized influence 222 to either back the fundee project pitch or series of pitches directly via their upvotes 224 of the fundee posts or comments thereof, or delegate their influence 226 to project curators 210c, who curate the best project pitches 228 and use the delegated influence 230 to upvote them 224 on behalf of the investors in consideration of project stakes received 232 by the funder or curator. Each vote has a monetary value in terms of the crowdfunding platform's cryptocurrency or tokens, and such value gets transferred to the fundee as part of project funding 234 with each upvote. In other words the influence tokens whether direct 222 or delegated 230, store value that can be liquidated in appropriate currency exchanges for funding the project 234, and the investors/influencers/influenstors receive project stake 232 in the form of rewards, gratuities, project equities, project tokens or coins from the project creators as a consideration for funding the project. The consensus engine produces new tokens 246 as peer rewards 248, which are distributed amongst the peer nodes as rewards either to the block/transaction/event validators or pooled in as funding pool 250 to be allocated to the participating peers according to their tokenized influence on the platform. The tokens from the funding pool can be used as investment tokens 252 to power up the funding votes 224 that support and fund the project pitches. The process of crowdfunding concludes with all the transactions, events and funding smart contracts being recorded in blocks and stored in a database of distributed ledger across all the validator/mining nodes that validate those transactions, events and smart contracts.

In a preferred embodiment the influence of participating peers on crowdfunding platform is tokenized based on the quantum of stake they posses in their accounts on the platform as project creators, project curators, or project investors, measured in terms of one or more of the following assets: i) cryptocurrency tokens they stake, ii) hashing power of the block/transaction/event producing peers, iii) their reputation scores, iv) intellectual property they own, and iv) activities they conduct on the platform.

In yet another preferred embodiment almost anything one owns and uses for personal or investment purposes is a capital asset that can be quantified and tokenized into influence capital for the purpose of acquiring or making new asset investments.

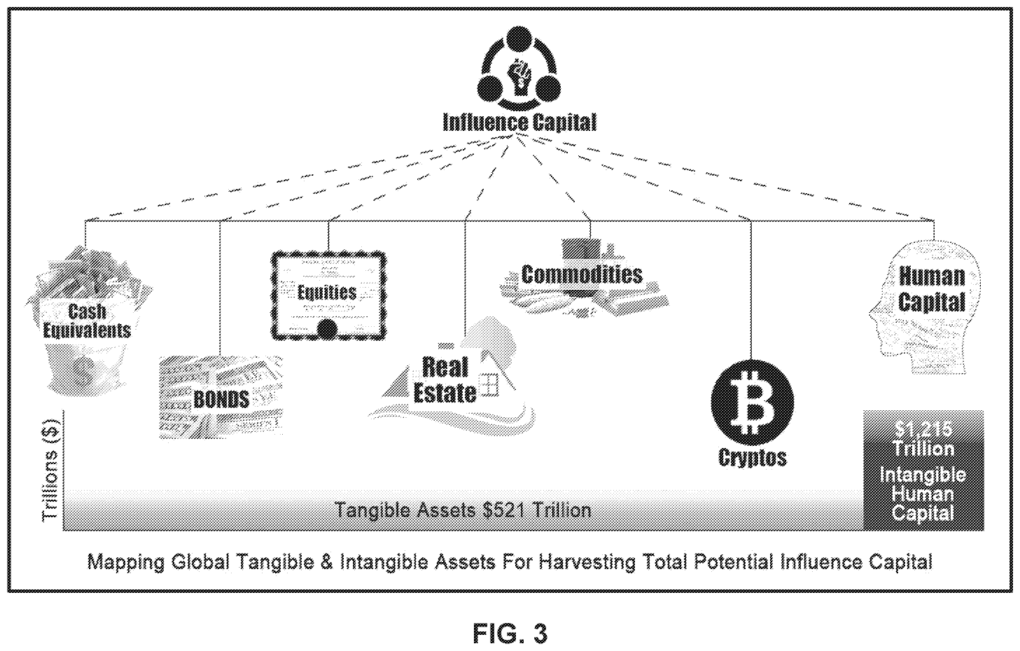

FIG. 3 is a block diagram illustrating the global landscape of all types of tangible and intangible asset classes known to prior art including but not limited to cash equivalents, bonds, equities, real estate, commodities, cryptocurrencies and human capital. Each of those asset classes can be tokenized to create a quadrillion-dollar worth Super Asset Class of Influence Capital.

In a preferred embodiment the DLT or blockchain network generates funds by taking a percentage from new tokens generated as block/transaction/event validation commission or reward, and placing it in the funding pool that allocates token rewards to the project pitches, project curators, block/transaction/event validators, and platform operators and investors. Such allocation is not less than 50% and not more than 90% to the project pitch creator or the fundee, not more than 20% and not less than 5% to the project pitch curators, not more than 15% and not less than 5% to the block/transaction/event validators, not more than 10%, and not less than 2% to the platform operators and influenstors.

In one preferred embodiment the tokens can either be pre-mined or generated as incentivized reward, fee or commission for verifying and validating DLT/blockchain transactions, events and smart contracts that create the project pitch, that curate the fundable project pitch, that vote the fundable project pitch, producing monitory rewards proportional to the transaction blocks they produce as block/transaction/event validators, project pitch creation activities they conduct as project creators, the curation activities they perform as project curators, and the stake they hold within the platform's token economy as project investors/influenstors.

In yet another preferred embodiment the tokens staked are either platform tokens generated by the block/transaction/event producing activity of the platform, or they are one or more of the established cryptocurrency tokens whether pegged/collateralized or not pegged/collateralized with the platform tokens, or pegged/collateralized with one or more fiat currency denominations or combination thereof. In another preferred embodiment, the staked tokens or project stakes are insured against unforeseeable losses.

In a preferred embodiment of the invention, the DLT is a low latency, zero transaction fee, and scalable blockchain. In yet another preferred embodiment the decentralization of the crowdfunding network is enabled by means of DAG (Directed Acyclic Graph) or any other DLT iteration known to prior art.

In still another preferred embodiment, the crowdfunding platform of the present invention is deployed for impact investment projects that implement one or more of the 17 sustainable development goals (SDG) of the United Nations' Agenda 2030 wherein the influencers, funders or Influenstors are either:
i) one or more of the 193 countries who are signatories to UN SDGs, or their nominees, or any of the SDG stakeholders in private sector;
ii) the SDG project creators or fundees are implementers, catalysts, facilitators or executors of the projects that target to accomplish one or more of the goals of the SDG;
iii) the SDG project curators are the nominees or delegatees of the influence of the influencers, funders, SDG stakeholders who use their delegated influence to curate the fundable SDG projects for funding them in consideration for a curation commission they receive.

In yet another preferred embodiment the crowdfunding platform is deployed for funding sustainability infrastructure projects that are undertaken pursuant to China's Belt and Road Initiative (BRI), and the sustainability stakeholders are BRI stakeholders.

In a preferred sustainability crowdfunding embodiment the cryptocurrency tokens staked are either platform's SDG tokens generated by the block/transaction/event producing activity of the platform, or they are one or more of the established cryptocurrency tokens, fiat currency or International Monetary Fund's (IMF's) Special Drawing Rights (SDR) reserve currency. The SDG tokens may be pegged or not pegged with one or more fiat currency denominations or combination thereof. Pegging and collateralizing a cryptocurrency with a stable fiat currency may provide some stability to the cryptocurrency.

Although the present invention has been particularly shown and described with reference to exemplary embodiments thereof, it will be understood by those of ordinary skill in the art that various changes in form and details may be made therein without departing from the spirit and scope of the present invention as defined by the appended claims. Therefore, the present embodiments are to be considered as illustrative and not restrictive and the invention is not to be limited to the written description.

1. A decentralized computer-implemented crowdfunding platform for incentivized and equitable sharing and monetization of influence of the peers, by the peers, for the peers, for the purpose of raising funds or kick starting projects exclusively by sharing or staking monetized or tokenized influence of participating peers for generating or mining new funds in one or more tokens or cryptocurrency denominations without any of the funders actually having to contribute any cash in monetary terms, essentially requiring no currency contribution in any form of fiat or cryptocurrency from a funder to a fundee for to acquiring a stake in the fundee project pursuant to a self-executing smart contract.

2. The crowdfunding platform of claim 1 wherein the peers are either project creators or fundees, who pitch their projects in one or more blog posts for funding; or, they are influencers, who are either the project curators or project investors, the latter either directly back the project pitches using their influence to vote the fundee's funding pitching blog posts or comments thereof, or delegate their influence to project curators, who curate the best project pitches and vote on behalf of the investors for a share in the rewards, gratuities, equities, tokens or coins received from the project creators as a consideration for the project funding received.

3. The computer-implemented platform of claim 1 wherein the decentralized network of peers deploys one or more iterations of distributed ledger technology (DLT) for security, privacy, anonymity, and generating or mining funds using one or more of the DLT iterations that include but not limited to low-latency blockchain or directed acyclic graph (DAG) or their variants therefore, using a transaction validation consensus protocol that includes but not limited to proof-of-work, proof-of-stake, delegated proof-of-stake or their variants thereof, for executing project funding smart contracts and storing them as distributed ledger across all DLT validation nodes.

4. The monetization of influence of claim 1 wherein any tangible or intangible asset class known to prior art can be quantified and tokenized into influence capital in one or more cryptocurrency denominations for the purpose of acquiring or making new asset investments in projects.

5. The crowdfunding platform of claim 1 wherein the influencers deliver funding as a series of project pitching blog post or comment upvotes, which are tokenized based on the quantum of stake participating peers posses in their accounts on the platform as project creators, project curators, or project investors/influenstors, measured in terms of one or more of the following assets:
i) cryptocurrency tokens they stake,
ii) hashing power of the block/transaction/event producing peers,
iii) their reputation scores,
iv) intellectual property they own, and,
v) activities they conduct on the platform.

6. The tokenized influence of claim 1 wherein the tokens are either pre-mined or generated as incentivized reward, fee or commission for verifying and validating DLT transactions, events or smart contracts:
that create the project pitch,
that curate the fundable project pitch,
that vote the fundable project pitch,
producing monitory rewards proportional to the transaction blocks they produce as block/transaction/event/transaction/event validators, project pitch creation activities they conduct as project creators, the curation activities they perform as project curators, and the stake they hold within the platform's token economy as influenstors.

7. The tokenized influence of claim 1 wherein the tokens staked are either platform tokens generated by the block producing activity of the platform, or they are one or more of the established cryptocurrency tokens whether pegged/collateralized or not pegged/collateralized with the platform tokens, or pegged/collateralized with one or more fiat currency denominations or combination thereof.

8. The crowdfunding platform of claim 1 wherein the DLT network generates funds by taking a percentage from new tokens generated as block/transaction/event validation commission or reward, and placing it in the funding pool that allocates token rewards to the project pitches, project curators, block/transaction/event validators, and platform operators and investors; not less than 50% and not more than 90% to the project pitch creators or the fundees, not more than 20% and not less than 5% to the project pitch curators, not more than 15% and not less than 5% to the block/transaction/event validators, not more than 10% and not less than 2% to the platform operators and investors.

9. The crowdfunding platform of claim 1 wherein the crowdfunding is reward based, donation based, equity based or token based initial coin offering, consequently the funders' stake granted in their projects, by fundees pursuant to self-executing smart contracts, is in the form of rewards, perks, gratuities, equities or tokens.

10. The computer-implemented crowdfunding platform of claim 1 wherein the staked tokens or project stakes are insured against unforeseeable losses.

11. The computer-implemented platform of claim 1 that crowdfunds one or more of the 17 sustainable development goals (SDG) of the United Nations' Agenda 2030 wherein the influencers or funders are either one or more of the 193 countries who are signatories to UN SDGs, or their nominees, or any of the SDG stakeholders in private sector; the SDG project creators or fundees are implementers, catalysts, facilitators or executors of the projects that target to accomplish one or more of the goals of the SDGs; the SDG project curators are the nominees or delegatees of the influence of the influencers, funders, SDG stakeholders who use their delegated influence to curate the fundable SDG projects for funding them in consideration for a curation commission they receive.

12. A decentralized computer-implemented method of crowdfunding projects exclusively by tokenizing and sharing influence of project backers on a crowdfunding platform for generating or mining funds in one or more cryptocurrency denominations without any of the funders/influenstors actually having to contribute any cash in monetary terms, essentially requiring no direct currency contribution in any form of fiat or cryptocurrency from a funder to a fundee for acquiring a stake in the fundee project pursuant to a self-executing smart contract, comprising of the steps of:
the project creator creating one or more blog posts to pitch to a crowd of influenstors and project curators for seeking funding from them in exchange for rewards, gratuities, equities, tokens or coins, pledged in a smart contract;
the influencers voting the project pitch or series of pitches from the project creator with a transferable vote value that is quantifiable to the quantum of stake they have on the crowdfunding platform in terms of the platform's cryptocurrency or tokens,
the project creator receiving funds equivalent to the influencers' vote value in platform's cryptocurrency or tokens, as per the terms and conditions of the funding smart contract and depending on the size of the funding pool;
the project creator converting the platform cryptocurrency or tokens into one or more appropriate spendable currencies in a cryptocurrency exchange,
the project creator or fundee delivering to the project backers/funders/influenstors such rewards, gratuities, equities, tokens or coins as pledged in the project pitch and the self-executing smart contract,
all the transactions, events, smart contracts being recorded and stored in a database of distributed ledger across all the peer nodes that validate those transactions, events, smart contracts.

13. The method of claim 12 wherein the peers are either project creators or fundees, who pitch their projects in one or more blog posts for funding; or the influencers who are either the project curators or project investors, the latter either directly back the project pitches using their influence to vote the fundee posts or comments thereof, or delegate their influence to project curators, who curate the best project pitches and vote on behalf of the investors for a share in the rewards, gratuities, equities, tokens or coins received to from the project creators as a consideration for the project funding received.

14. The computer-implemented method of claim 12 wherein the decentralized network of peers deploys one or more iterations of distributed ledger technology (DLT) for security, privacy, anonymity, and generating or mining funds using one or more of the DLT iterations that include but not limited to low-latency blockchain or directed acyclic graph (DAG) or their variants therefore, using a transaction validation consensus protocol that includes but not limited to proof-of-work, proof-of-stake, delegated proof-of-stake or their variants thereof; and tokenized for incentivizing peer participation by means of producing monitory rewards proportional to the project pitch creation or curation activities they conduct, transaction validations they produce for executing project funding smart contracts and storing them as distributed ledger across all validation nodes, and stake they hold within the platform's token economy.

15. The tokenized influence of claim 12 wherein any tangible or intangible asset class known to prior art can be quantified and tokenized into influence capital in one or more cryptocurrency denominations for the purpose of acquiring or making new asset investments in projects.

16. The crowdfunding method of claim 12 wherein the influencers deliver funding as a series of project pitching blog post upvotes or comment upvotes, which are tokenized based on the quantum of stake participating peers posses in their accounts on the platform as project creators, project curators, or project investors, measured in terms of one or more of the following assets: i) cryptocurrency tokens they stake, ii) hashing power of the block/transaction/event producing peers, iii) their reputation scores, iv) intellectual property they own, and iv) activities they conduct on the platform.

17. The tokenized influence of claim 12 wherein the tokens are either pre-mined or generated as incentivized reward, fee or commission for verifying and validating transactions, events and smart contracts that create the project pitch, that curate the fundable project pitch, that vote the fundable project pitch, producing monitory rewards proportional to the transactions, events, smart contracts they validate as validators, project pitch creation activities they conduct as project creators, the curation activities they perform as project curators, the stake they hold within the platform's token economy as project investors/influenstors.

18. The tokenized influence of claim 12 wherein the tokens staked are either platform tokens generated by the block/transaction/event producing activity of the platform, or they are one or more of the established cryptocurrency tokens whether pegged/collateralized or to not pegged/collateralized with the platform tokens, or pegged/collateralized with one or more fiat currency denominations or combination thereof.

19. The crowdfunding method of claim 12 wherein the decentralized network generates funds by taking a percentage from new tokens generated as transaction, event, smart contract or block/transaction/event validation commission or reward, and placing it in the funding pool that allocates token rewards to the project creators, project curators, block/transaction/event validators, and platform operators and investors; not less than 50% and not more than 90% to the project pitch creators or the fundees, not more than 20% and not less than 5% to the project pitch curators, not more than 15% and not less than 5% to the block/transaction/event validators, not more than 10% and not less than 2% to the platform operators and investors.

20. The crowdfunding method of claim 12 wherein the crowdfunding is reward based, donation based, equity based or token based initial coin offering, consequently the funders' stake granted in their projects by the fundees pursuant to self-executing smart contracts, is in the form of rewards, perks, gratuities, equities or tokens.

21. The computer-implemented method of claim 12 that crowdfunds one or more of the 17 sustainable development goals (SDG) of the United Nations' Agenda 2030 wherein the peers are either one or more of the 193 influencer, funder countries who are signatories to UN SDGs, or their nominees, or any of the SDG stakeholders in private sector; the SDG project creators or fundees are implementers, catalysts, facilitators or executors of the projects that target to achieve one or more of the goals of the SDG; the SDG project curators are the nominees or delegatees of the influence of the influenstors, funders, SDG stakeholders who use their delegated influence to curate the fundable SDG projects for funding them in consideration for a curation commission they receive.

22. A decentralized computer-implemented method of raising impact investments for crowdfunding the $2.5 Trillion annual funding gap of United Nation's Agenda 2030 Sustainable Development Goals (SDG) budget, from the global sustainability stakeholders, exclusively by tokenizing and sharing influence of one or more of the 193 SDG signatory countries or their nominees, or any of the sustainability stakeholders in private sector, for generating or mining funds in one or more cryptocurrency denominations without any of the funders/influenstors actually having to contribute any cash in monetary terms, essentially requiring no direct currency contribution in any form of fiat or cryptocurrency from an SDG funder to a sustainability fundee for acquiring a to stake in the fundee's sustainability project pursuant to a self-executing smart contract, comprising of the transaction steps of:
the global sustainability project creator creating one or more blog posts to pitch to a crowd of SDG influencers and SDG project curators for seeking funding from them in exchange for rewards, gratuities, equities, tokens or coins, pledged in a smart contract;
the SDG influenstors or their nominees or SDG project curators voting the project pitch or series of pitches from the project creator with a vote value that is quantifiable to the quantum of stake they have on the crowdfunding platform in terms of the platform's SDG cryptocurrency or tokens,
the SDG project creator or fundee receiving the funds equivalent to the influencers' vote value in platform's SDG cryptocurrency or tokens, as per the terms and conditions of the funding smart contract and depending on the size of the funding pool;
the SDG project creator or fundee converting the platform's SDG cryptocurrency or tokens into one or more appropriate spendable currencies in a cryptocurrency exchange,
the SDG project creator or fundee delivering to the SDG project backers, funders, influenstors such rewards, gratuities, equities, tokens or coins as pledged in the project pitch and the self-executing smart contract,
all the transactions, events, smart contract being recorded and stored in a database of distributed ledger across all the peer nodes that validate the transactions, events, smart contracts.

23. The cryptocurrency tokens of claim 22 wherein the tokens staked are either platform's SDG tokens generated by the block producing activity of the platform, or they are one or more of the established cryptocurrency tokens, fiat currency or International Monetary Fund's (IMF's) Special Drawing Rights (SDR) reserve currency, whether pegged/collateralized or not pegged/collateralized with the platform's SDG tokens, or pegged/collateralized with one or more fiat currency denominations or combination thereof.

24. The cryptocurrency or tokens of claim 22 wherein the cryptocurrency or tokens are either backed by the plurality of United Nations' Vision 2030 signatory countries or are insured against unforeseeable losses.

25. The global sustainability projects and stakeholders of claim 22 wherein the sustainability projects are related to China's Belt and Road Initiative (BRI), and the stakeholders are BRI stakeholders.
